(19) United States
(12) Patent Application Publication
(10) Pub. No.: US 2021/0013545 A1
(43) Pub. Date: Jan. 14, 2021

(54) ELECTROLYTE SOLUTION FOR A LITHIUM ION CELL

(71) Applicant: Honeywell International Inc., Morris Plains, NJ (US)

(72) Inventors: Hui Wang, Shanghai (CN); Ya Qun Liu, Shanghai (CN); Ying Han, Shanghai (CN); Gang Xu, Shanghai (CN); Jian Hou, Shanghai (CN); Shuwen Peng, Shanghai (CN); Rajiv Ratna Singh, Buffalo, NY (US)

(21) Appl. No.: 16/921,323

(22) Filed: Jul. 6, 2020

Related U.S. Application Data
(60) Provisional application No. 62/873,555, filed on Jul. 12, 2019.

(51) Int. Cl. H01M 10/0567; H01M 10/0525; H01M 4/505; H01M 4/525

(52) U.S. Cl. CPC H01M 10/0567; H01M 10/0525; H01M 2004/028; H01M 4/525; H01M 4/505

(57) ABSTRACT

An electrolyte solution for a lithium-ion cell includes at least one organic carbonate solvent, at least one lithium salt including a non-coordinating anion and at least one polyfluorinated alkoxy olefin according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,

wherein Rₐ and Rₐ′ are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

### CROSS-REFERENCE TO RELATED APPLICATION

This application claims the benefit of U.S. Provisional Application No. 62/873,555, filed Jul. 12, 2019, which is herein incorporated by reference in its entirety.

### FIELD

The present disclosure is related to electrolytes for lithium-ion cells for use in lithium-ion batteries. More specifically, the present disclosure is related to electrolyte solutions for lithium-ion cells.

### BACKGROUND

Lithium-ion cells are of particular importance in applications ranging from cellular phones to electric vehicles. However, to be of practical use, cells must maintain performance over multiple cycles, and must be able to perform at a variety of temperatures. One factor in performance and lifetime of a cell is the decomposition of electrolytes present in the cell, as the electrolytes react with either electrons or the electrodes' conduction band. To combat such undesired reactions, additives are combined with the electrolyte solutions. These additives decompose to form a solid electrolyte interphase (SEI) layer on the electrodes. The SEI layer consists essentially of insoluble products of decomposition of the additives. The SEI layer provides a barrier for electron tunneling to the electrolyte, thus preventing decomposition of the electrolytes. However, the SEI layer also introduces a barrier for lithium-ion intercalation into the electrodes, which can increase the cell's internal electric resistance and negatively impact cell performance, particularly at low temperatures.

The electrolyte composition is of further importance for considerations of safety. In the case of a thermal runaway, the high rate of gas generation resulting from electrolyte decomposition can produce high-pressure conditions in a cell. This can result in the venting of flammable electrolyte vapor. The SEI layer is a key element in determining the power capability, safety shelf life, and cycle life of a cell, by preventing decomposition of the electrolyte.

Additives in current use may not perform well at higher voltages or higher temperatures. In order to improve lithium-ion cell performance and safety under these conditions, improved electrolyte solutions are needed.

### SUMMARY

In one embodiment, the present invention provides an electrolyte solution for a lithium-ion cell. The electrolyte solution includes at least one organic carbonate solvent, at least one lithium salt including a non-coordinating anion, and at least one polyfluorinated alkoxy olefin according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
   wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

In another embodiment, the present invention provides a lithium-ion cell for a lithium-ion battery. The lithium-ion cell includes a cathode, an anode, a porous separator between the cathode and the anode, an electrolyte solution disposed between the cathode and the anode, and a solid electrolyte interphase layer disposed on the cathode and the anode, the solid electrolyte interface layer including a decomposition product of at least one polyfluorinated alkoxy olefin according to the general formula I, the general formula II, or the general formula III:
RₐR_{b}C═CH—O—R,
II: RₐR_{b}C═CH—O—CHRₐ′R_{b}′,
III: RₐR_{b}C═CH—O—R_{c}—O—CH⊚CRₐ′R_{b}′,
   wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

In yet another embodiment, the present invention provides a method for making an electrolyte solution for a lithium-ion cell. The method includes providing at least one polyfluorinated alkoxy olefin and combining the at least one polyfluorinated alkoxy olefin with at least one organic carbonate solvent and at least one lithium salt including a non-coordinating anion, wherein the at least one polyfluorinated alkoxy olefin is according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
   wherein Rₐ and Rₐ′ are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

### DESCRIPTION OF THE DRAWINGS

FIGS. 1A-1C shows a lithium-ion cell, according to this disclosure.

FIG. 2 shows a graph of capacity retention versus cycle number for lithium-ion cells with and without 1-methoxy-3,3,3-trifluoropropene at 25° C.

FIG. 3 shows a graph of capacity retention versus cycle number for lithium-ion cells with and without 1-methoxy-3,3,3-trifluoropropene at 45° C.

FIG. 4 shows a graph of voltage (mV) versus capacity retention during discharge at −20° C. for lithium-ion cells with and without 1-methoxy-3,3,3-trifluoropropene.

### DETAILED DESCRIPTION

The present inventors have found that the use of at least one polyfluorinated alkoxy olefin according to Formula I, Formula II or Formula III below as an additive in an electrolyte solution improves performance of lithium-ion cells under a variety of conditions. The at least one polyfluorinated alkoxy olefin decomposes in solution to form solid electrolyte interphase (SEI) layer on the electrodes. This SEI layer provides improved performance in lithium-ion cells compared to SEI layers formed by industry standard additives, particularly under higher-temperature and higher-voltage conditions.

Under high temperature storage conditions, the SEI layer may grow overly thick, thus reducing performance of the lithium-ion cell. The present inventors have found that the use of the at least one polyfluorinated alkoxy olefin as an additive results in an improvement in this characteristic as well, allowing the lithium-ion cell to perform well even after storage under high temperature conditions.

The at least one polyfluorinated alkoxy olefin is a fluoridated additive that is able to react with hydrogen radicals to produce hydrogen fluoride and inhibit flame propagation. Thus, the at least one polyfluorinated alkoxy olefin as an additive improves the safety of lithium-ion cells.

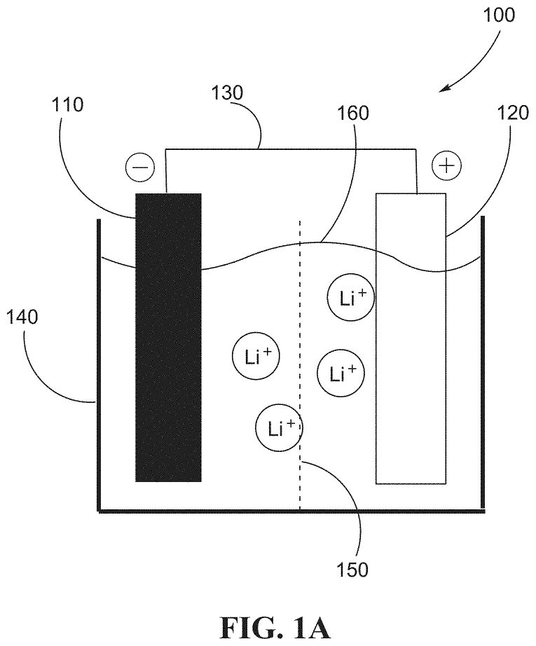

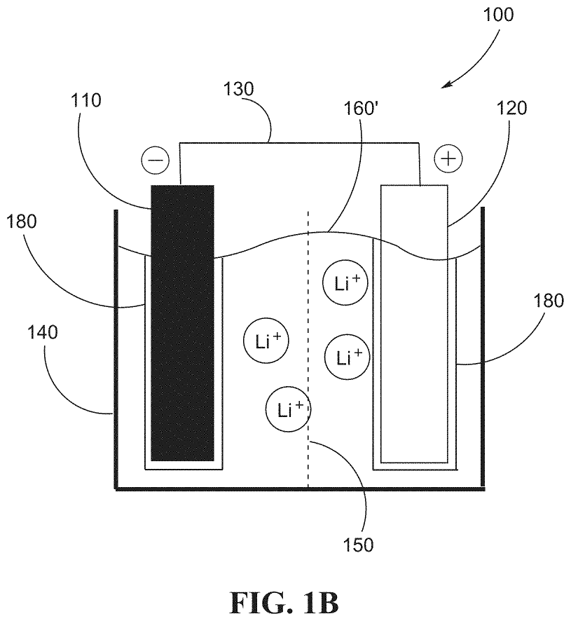

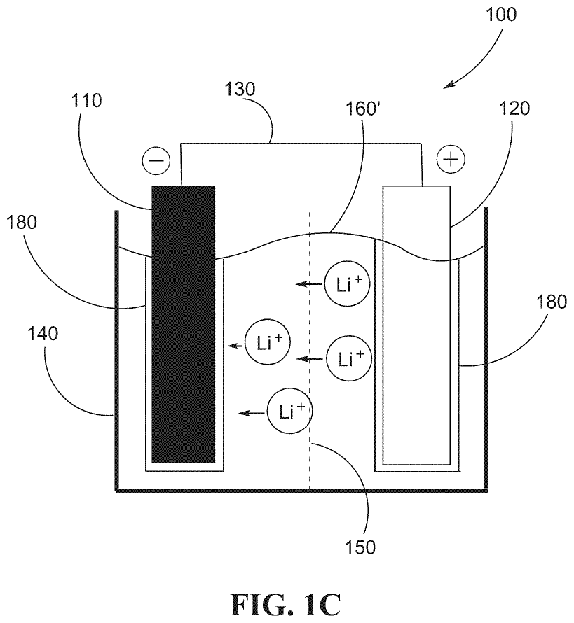

The present disclosure provides an electrolyte solution for a lithium-ion cell. FIG. 1A is a schematic illustration of a lithium-ion cell 100 prior to its first charge/discharge cycle. The lithium-ion cell 100 includes an anode 110, a cathode 120, a conductor 130, a container 140, a separator 150, and an electrolyte solution 160. The electrolyte solution 160 is contained by the container 140. The anode 110, the cathode 120 and the separator 150 are at least partially immersed in the electrolyte solution 160 so that the electrolyte solution 160 is disposed between the anode 110 and the cathode 120, and the separator 150 disposed between the anode 110 and the cathode 120. The conductor 130 can be any electrically conductive device that electrically connects the anode 110 and the cathode 120, such as a wire or conductive film, for example.

The anode 110 may be carbon, artificial graphite, or any other anode material suitable for use in a lithium-ion cell, such as the lithium-ion cell 100. The cathode 120 may be lithium cobalt oxide (LCO), lithium nickel manganese cobalt oxide (NMC), lithium manganese oxide (LMO), lithium manganese cobalt oxide (LMC), lithium iron phosphate (LFP), lithium nickel cobalt aluminum oxide (NCA), lithium titanate (LTO), or any other material suitable for use in the lithium-ion cell 100.

The separator 150 is a porous membrane made of a polymer, such as polypropylene, polyethylene, and polyimide, or co-polymers of these materials, for example. The porosity of the separator 150 may be as low as about 40%, about 50%, or about 60%, or as high as about 70%, about 80% or about 90%, or be within any range defined between any two of the foregoing values, such as about from 40% to about 90%, from about 50% to about 80%, from about 60% to about 70%, from about 60% to about 90%, or from about 40% to about 60%, for example.

The electrolyte solution 160 includes at least one organic carbonate solvent, at least one lithium salt including a non-coordinating anion, and at least one polyfluorinated alkoxy olefin. The at least one organic carbonate solvent may include ethylene carbonate, dimethyl carbonate, diethyl carbonate, propylene carbonate, ethyl methyl carbonate, or combinations thereof, for example. The at least one organic carbonate solvent may include ethylene carbonate, propylene carbonate and diethyl carbonate. The at least one organic carbonate solvent may consist essentially of ethylene carbonate, propylene carbonate and diethyl carbonate. The at least one organic carbonate solvent may consist of ethylene carbonate, propylene carbonate and diethyl carbonate. The at least one organic carbonate solvent may include ethylene carbonate, ethyl methyl carbonate and diethyl carbonate. The at least one organic carbonate solvent may consist essentially of ethylene carbonate, ethyl methyl carbonate and diethyl carbonate. The at least one organic carbonate solvent may consist of ethylene carbonate, ethyl methyl carbonate and diethyl carbonate.

The at least one lithium salt with a non-coordinating anion may include lithium hexafluorophosphate, lithium tetrafluoroborate, lithium perchlorate, lithium bis(fluorosulfonyl)imide, or combinations thereof, for example. The lithium salt with a non-coordinating anion may be present in the electrolyte solution 160 in an amount as low as about 0.5 weight percent (wt. %), about 1.0 wt. %, about 1.5 wt. %, about 2.0 wt. %, or about 2.5 wt. %, or as high as about 3.0 wt. %, about 4.0 wt. %, about 5.0 wt. %, about 10 wt. %, or about 15 wt. %, or be within any range defined between any two of the foregoing values, such as from about 0.5 wt. % to about 15 wt. %, from about 1.0 wt. % to about 10 wt. %, from about 1.5 wt. % to about 5.0 wt. %, from about 2.0 wt. % to about 4.0 wt. %, from about 2.5 wt. % to about 3.0 wt. %, from about 0.5 wt. % to about 3.0 wt. %, from about 2.0 wt. % to about 5.0 wt. %, or from about 1.5 wt. % to about 2.5 wt. %, for example.

The at least one polyfluorinated alkoxy olefin is according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,

wherein Rₐ and Rₐ40 are each independently a fluorinated alkyl group having 1 or 2 carbon atoms, R_{b} and R_{b}′ are each independently F, Cl, Br or H, R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

For example, if the at least one polyfluorinated alkoxy olefin is according to general formula I, and Rₐ is a trifluoromethyl group, R_{b} is H, n=1, x=3, and y=0, then the at least one polyfluorinated alkoxy olefin is 1-methoxy-3,3,3-trifluoropropene. In another example, if the at least one polyfluorinated alkoxy olefin is according to the general formula I, and Rₐ is a trifluoromethyl group, R_{b} is H, n=2, x=5, and y=0, then the at least one polyfluorinated alkoxy olefin is 1-ethoxy-3,3,3-trifluoropropene.

The at least one polyfluorinated alkoxy olefin may be present in in the electrolyte solution 160 in an amount as low as about 0.2 wt. %, about 0.5 wt. %, about 1.0 wt. %, about 2.0 wt. %, about 3.0 wt. %, about 4.0 wt. %, or about 5.0 wt. %, or as high as about 6.0 wt. %, about 7.0 wt. %, about 8.0 wt. %, about 9.0 wt. %, or about 10.0 wt. %, or be within any range defined between any two of the foregoing values, such as from about 0.2 wt. % to about 10.0 wt. %, from about 0.5 wt. % to about 9.0 wt. %, from about 1.0 wt. % to about 8.0 wt. %, from about 2.0 wt. % to about 7.0 wt. %, from about 3.0 wt. % to about 6.0 wt. %, from about 0.5 wt. % to about 6.0 wt. %, from about 4.0 wt. % to about 9.0 wt. %, or from about 6.0% weight to about 10.0% weight, for example. All weight percentages of the at least one polyfluorinated alkoxy olefin are as a weight percentage of the total electrolyte solution 160.

The at least one polyfluorinated alkoxy olefin exists as a trans-fluorinated isomer (trans-isomer) or a cis-fluorinated isomer (cis-isomer). The boiling point of the electrolyte solution 160 can vary depending upon the ratio of the two isomers in the electrolyte solution 160, with higher-boiling point solutions including a greater amount of the cis-isomer. For example, if the fluorinated isomer is 1-methoxy-3,3,3-trifluoropropene, the boiling point of the electrolyte solution 160 can range from about 60° C. to about 102° C. Thus, depending upon the desired application, the ratio of the trans- to cis-isomers may be varied to give a desirable boiling point. For example, lithium-ion cells used in electric vehicles may require mixtures with boiling points greater than about 80° C.

The at least one polyfluorinated alkoxy olefin may include the cis-isomer. The at least one polyfluorinated alkoxy olefin may consist essentially of the cis-isomer. The at least one polyfluorinated alkoxy olefin may consist of the cis-isomer. The at least one polyfluorinated alkoxy olefin may include the trans-isomer. The at least one polyfluorinated alkoxy olefin may consist essentially of the trans-isomer. The at least one polyfluorinated alkoxy olefin may consist of the trans-isomer.

The at least one polyfluorinated alkoxy olefin may consist of the trans-isomer and the cis-isomer. The amount of the trans-isomer as a percentage of the at least one polyfluorinated alkoxy olefin (or as a percentage of the total weight of the trans-isomer and the cis-isomer) may be as low as about 1 wt. %, 2 wt. %, 5 wt. %, 10 wt. %, 20 wt. %, 30 wt. %, or 40 wt. %, or as high as about 50 wt. %, 60 wt. %, 70 wt. %, 80 wt. %, 90 wt. %, 95 wt. %, 98 wt. %, or 99 wt. %, or be within any range defined between any two of the foregoing values, such as from about 1 wt. % to about 99 wt. %, about 2 wt. % to about 98 wt. %, about 5 wt. % to about 95 wt. %, about 10 wt. % to about 90 wt. %, about 20 wt. % to about 80 wt. %, about 30 wt. % to about 70 wt. %, 40 wt. % to about 60 wt. %, about 40 wt. % to about 50 wt. %, about 1 wt. % to about 60 wt. %, about 5 wt. % to about 40 wt. %, or about 90 wt. % to about 99 wt. %, for example.

The electrolyte solution 160 may further include additives in addition to the at least one polyfluorinated alkoxy olefin. The additives may improve various performance aspects of the battery, such as improved performance at high temperatures, improved performance at very low temperatures, reduced electrolyte degassing during battery operation, and/or reduced internal resistance, for example. The additional additives may include vinylene carbonate, fluoroethylene carbonate, 2-propynyl methanesulfonate, cyclohexylbenzene, t-amyl benzene, adiponitrile, or any combinations thereof.

The electrolyte solution 160 may be produced by providing the at least one polyfluorinated alkoxy olefin and combining the at least one polyfluorinated alkoxy olefin with the at least one organic carbonate solvent and the at least one lithium salt including a non-coordinating anion. The at least one polyfluorinated alkoxy olefin, the at least one organic carbonate solvent and the at least one lithium salt including a non-coordinating anion are as described above.

The at least one polyfluorinated alkoxy olefin may be provided in a number of ways. For example, one possible method of synthesis is the reaction of a hydrofluoroolefin (HFO) monomer, such as 2,3,3,3-tetrafluoropropene; 1,3,3,3-tetrafluoropropene; 1-chloro-2,3,3,3-tetrafluoropropene, 1-bromo-3,3,3-trifluoropropene or 1-chloro-3,3,3-trifluoropropene, for example, with and alkane alcohol, such as methanol, ethanol, propanol, butanol, fluoromethanol, 2,2,2-trifluoroethanol, ethylene glycol, propylene glycol, butanediol, for example, in the presence of a catalyst, as described in detail in U.S. patent application Ser. No. 15/606,400, the contents of which is herein incorporated by reference in its entirety. As disclosed in U.S. patent application Ser. No. 15/606,400, an alcohol and the catalyst may be mixed together in a reaction vessel, and then the HFO monomer may be added to mixture in the reaction vessel. For example, if the HFO monomer selected is 1-chloro-3,3,3-trifluoropropene and the alcohol selected is methanol, then the resulting compound is 1-methoxy-3,3,3-trifluoropropene. The catalyst can be an alkali hydroxide, such as sodium hydroxide or potassium hydroxide, for example. The molar ratio of the HFO monomer to the alkane alcohol may range from 10:1 to 1:20. The molar ratio of the HFO monomer to the catalyst may range from 100:1 to 1:5. The alkane alcohol functions as a solvent for the reaction. The alkane alcohol also functions as a halogen substituent. For example, if the HFO monomer is 1-chloro-3,3,3-trifluoropropene and the alkane alcohol is methanol, the methanol functions as a chlorine substituent, replacing the chlorine atom which is removed from the 1-chloro-3,3,3-trifluoropropene to form a methoxy group of the 1-methoxy-3,3,3-trifluoropropene. In another example, if the HFO monomer is 1-chloro-3,3,3-trifluoropropene and the alkane alcohol is ethylene glycol, the ethylene glycol functions a double chlorine substituent, replacing a chlorine atom removed from each of two molecules of 1-chloro-3,3,3-trifluoropropene to form an ethoxy group linking the two monomers to form 1,2-bis(3,3,3-trifluoropropeneoxy)ethane.

FIG. 1B is a schematic illustration of the lithium-ion cell 100 after its first charge/discharge cycle. As shown in FIG. 1B, the lithium-ion cell 100 now includes a solid electrolyte interphase (SEI) layer 180 disposed on the anode 110 and the cathode 120. The electrolyte solution 160′ in FIG. 1B is the electrolyte solution 160 described above in reference to FIG. 1A, except that the amount of the at least one polyfluorinated alkoxy olefin in the electrolyte solution 160′ has decreased significantly from the amount in the electrolyte solution 160 as the at least one polyfluorinated alkoxy olefin decomposes and forms part of the SEI layer 180 during the first charge/discharge cycle. The amount of the at least one polyfluorinated alkoxy olefin in the electrolyte solution 160′ may be less than 0.1 wt. % of the electrolyte solution 160′.

The thickness of the SEI layer 180 is determined, at least in part, by the concentration of the at least one polyfluorinated alkoxy olefin in the electrolyte solution 160 (FIG. 1A). The SEI layer 180 formed from the decomposition product of the at least one polyfluorinated alkoxy olefin is believed have a high concentration of lithium ion channels for the lithium ions to pass through, while also providing good electron insulation, blocking the injection of electrons from the anode 110 and the cathode 120 into the electrolyte solution 160′ to enable the cell to function well at higher voltages.

FIG. 1C is a schematic illustration of the lithium-ion cell 100 when charging. When the lithium-ion cell 100 charges, the lithium ions intercalated into the cathode 120 flow from the cathode 120, through the SEI layer 180 on the cathode 120, into the electrolyte solution 160′ between the cathode 120 and the separator 150, through the pores of the separator 150 and into the electrolyte solution 160′ between the separator 150 and the anode 110, through the SEI layer 180 on the anode 110, and intercalate into the anode 110.

When the lithium-ion cell 100 discharges (not shown) to provide power, the flow is reversed from that shown in FIG. 1C, as the lithium ions intercalated into the anode 110 flow from the anode 110, through the SEI layer 180 on the anode 110, into the electrolyte solution 160′ between the anode 110 and the separator 150, through the pores of the separator 150 and into the electrolyte solution 160′ between the separator 150 and the cathode 120, through the SEI layer 180 on the cathode 120, and intercalate into the cathode 120.

As used herein, the phrase “within any range defined between any two of the foregoing values” literally means that any range may be selected from any two of the values listed prior to such phrase regardless of whether the values are in the lower part of the listing or in the higher part of the listing. For example, a pair of values may be selected from two lower values, two higher values, or a lower value and a higher value. As used herein, the singular forms “a”, “an” and “the” include plural unless the context clearly dictates otherwise.

With respect terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error or minor adjustments made to optimize performance, for example. In the event it is determined that individuals having ordinary skill in the relevant arts would not readily ascertain values for such reasonably small differences, the terms “about” and “approximately” can be understood to mean plus or minus 10% of the stated value.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances that fall within the scope of the appended claims.

### EXAMPLES

In Examples 1-3 below, two lithium-ion cells were tested to demonstrate aspects of their performance under various conditions. The first cell (Cell 1) was a 4.2V pouch cell with a capacity of 1000 mAh. The cathode was made of LiNi_{0.3}Co_{0.3}Mn_{0.3}O₂ (NMC) and the anode was made of artificial graphite (AG). The electrolyte solution consisted of a solvent including ethylene carbonate (EC), diethyl carbonate (DEC), and ethyl methyl carbonate (EMC) in a 3:2:5 (weight:weight:weight) ratio, lithium hexafluorophosphate (LiPF₆) at a 1 molar concentration, and industry-standard additives for forming an SEI layer, the additives including vinylene carbonate (VC) and LiO₂PF_{2.} The electrolyte content was 3.5 g/Ah. The second cell (Cell 2) was identical to Cell 1, except that the industry standard additives were replaced with 1-methoxy-3,3,3-trifluoropropene in an amount of 1% of the total weight of the electrolyte solution.

### Example 1

### Efficiency, Discharge Capacity, and Resistance Testing

In this Example, each of the lithium-ion cells described above are tested at 0.2C (charging current is 20% of the working current). The efficiency (percentage of charging current stored in the cell) and discharging capacity of the cells are measured. The results of this test are shown in Table 1.

Next, the direct current internal resistance (DCIR) was measured during both charge and discharge at room temperature and 50% charge. The results from each of two runs for each of the two cells are shown in Table 1.

TABLE 1

| | | 1^{st} cycle | | | |
|---|---|---|---|---|---|
| | | 0.2 C | | DCIR (Ohms) | |
| | | | Discharge capacity | RT, 50% charge | |
| Cell | Electrolyte | Efficiency | (mAh) | Charge | Discharge |
| 1 | Industry | 87.33% | 1151.22 | 98.22 | 96.78 |
| | standard | | | 90.56 | 88.56 |
| 2 | 1-methoxy- | 88.15% | 1178.00 | 109.56 | 108.26 |
| | 3,3,3- | | | 90.60 | 89.49 |
| | trifluoropropene | | | | |

The results for the DCIR tests are similar for each of the cells. However, in both efficiency and discharging capacity, Cell 2 with the SEI layer formed from the decomposition products of 1-methoxy-3,3,3-trifluoropropene outperforms Cell 1.

### Example 2

### Capacity Retention at Varied Temperatures

Each cell is tested at different temperatures. First, capacity retention is measured at −20° C. at 30% charge rate to indicate low temperature (LT) discharge. Next, cells are tested after being stored at 60° C. for 30 days to measure performance following high temperature (HT) storage. Capacity retention, capacity recovery, and growth impedance are each measured, and the results are shown in Table 2 for each of two runs for each cell.

Finally, each cell is measured under room temperature (RT) and high temperature (HT) cycling conditions to determine capacity retention. For RT cycles, the cells are tested at 25° C. at 1C for both charge and discharge over 850 cycles. For HT cycles, the cells are tested at 45° C. at 1C for both charge and discharge rates over 600 cycles. Results are shown in Table 2.

| | LT | | | | RT cycle | HT cycle |
|---|---|---|---|---|---|---|
| | discharge | HT storage | | | (25° C., 1 C/1 C, | (45° C., 1 C/1 C, |
| | (−20° C., 0.3 C) | (60° C. 30 days) | | | 850 cycles) | 600 cycles) |
| | Capacity | Capacity | Capacity | Growth | Capacity | Capacity |
| Cell | Retention | Retention | Recovery | Impedance | Retention | Retention |
| 1 | 75.02% | 83.79% | 87.90% | 18.86% | 80.12% | 79.02% |
| | | 84.81% | 88.78% | 17.29% | | |
| 2 | 72.17% | 90.29% | 94.91% | 15.10% | 88.53% | 82.49% |
| | | 90.38% | 94.42% | 16.24% | | |

Under conditions of LT discharge, Cell 1 performed better than Cell 2. However, under all other tested conditions (HT storage, RT cycling and HT cycling), Cell 2, with the SEI layer formed from the decomposition products of 1-methoxy-3,3,3-trifluoropropene, performed better, showing its improvement over the industry standard.

### Example 3

### Charging and Discharging at Varied Temperatures

Two lithium-ion cells are tested to demonstrate charging and discharging under HT, RT, and LT conditions. The cells are 4.4V pouch cells with a capacity of 1000 mAh. The cathode is LiNi_{0.5}Co_{0.2}Mn_{0.3}O₂ (NMC) and the anode is artificial graphite (AG). The solvent is a mixture of ethylene carbonate (EC), diethyl carbonate (DEC), and ethyl methyl carbonate (EMC) in a 3:2:5 (weight:weight:weight) ratio, with 1.0 molar lithium hexafluorophosphate (LiPF₆). The first cell (Cell 1) includes an industry standard additive. The second cell (Cell 2) includes 1-methoxy-3,3,3-trifluoropropene in an amount of 1%.

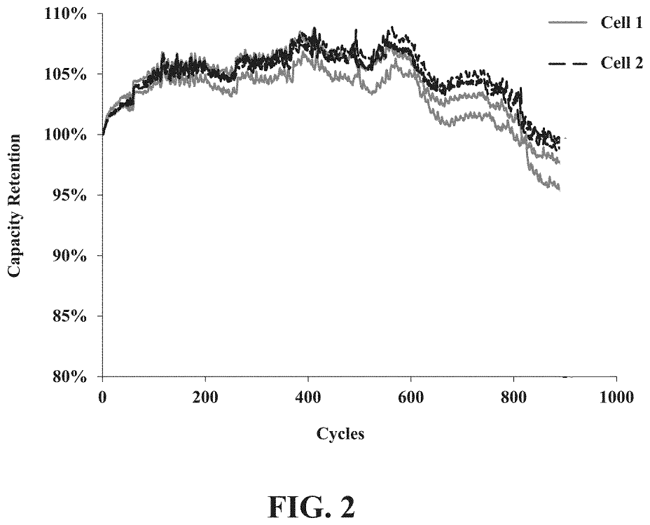

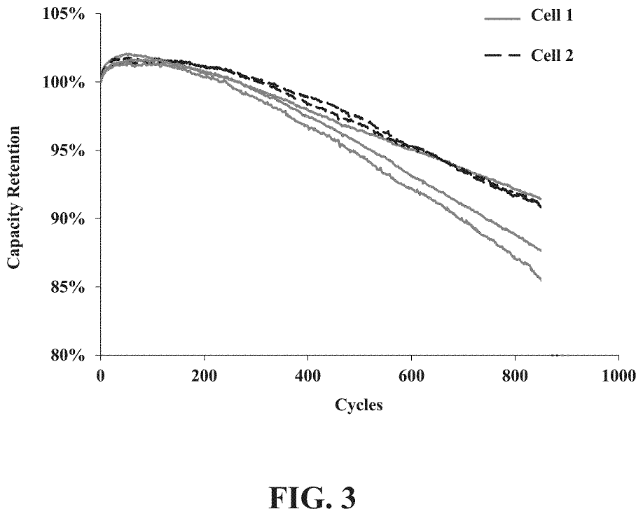

First, the cells are tested from 3.0V to 4.4V at RT (25° C.), both charging and discharging at 1C over 900 cycles. Results are shown as capacity retention versus cycle number in FIG. 2. Next, the cells are tested from 3.0V to 4.4V at HT (45° C.), both charging and discharging at 1C over 900 cycles. Results are shown as capacity retention over versus cycle number in FIG. 3. In both cases, Cell 2 (with the SEI layer formed from the decomposition products of 1-methoxy-3,3,3-trifluoropropene) performs better than Cell 1, retaining higher capacity over a larger number of cycles.

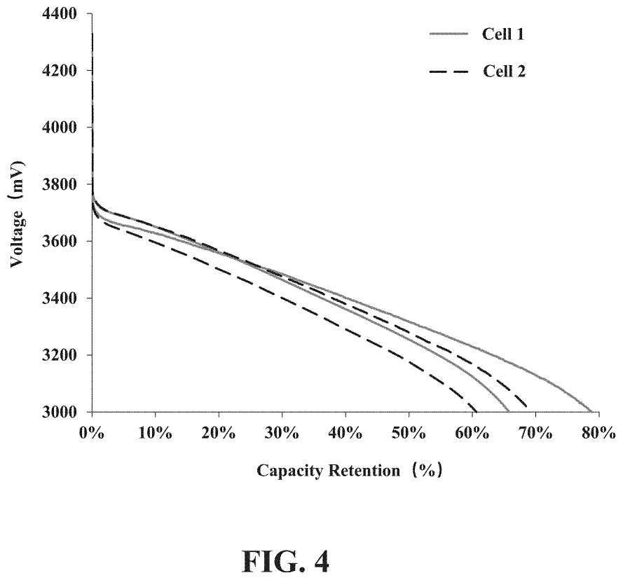

Next, the cells were discharged from 4.4V to 3.0V at 0.3C at LT (−20° C.). Results are shown as voltage (mV) versus capacity retention in FIG. 4. In this case, the cell including 1-methoxy-3,3,3-trifluoropropene did not perform better than the cell including the industry standard additive. These results show that, although the use of 1-methoxy-3,3,3-trifluoropropene as an additive in an electrolyte solution does not improve lithium-ion cell performance under LT storage conditions, it improves their performance during cycling at RT under HT storage conditions.

### Example 4

### Production of 1-Methoxy-3,3,3-trifluoropropene

In this Example, a method for making 1-methoxy-3,3,3-trifluoropropene is demonstrated. A 300-mL autoclave was charged with 30 mL of methanol and 33.6 g of solid potassium hydroxide, and then the autoclave was sealed. 80 g of 1-chloro-3,3,3-trifluopropropene was condensed into the autoclave through a valve. The autoclave was heated to 70° C. and maintained at 70° C. for four hours. After 4 hours, the autoclave was cooled, and then opened. The contents of the autoclave were poured into water and then the mixture was shaken. After shaking, a lower organic layer formed and was separated from the mixture. The contents of the lower organic layer were dried over calcium chloride. The resulting dried organic mixture was distilled and 1-methoxy-3,3,3-trifluoropropene was obtained.

### Example 5

### Production of 1-Ethoxy-3,3,3-trifluoropropene

In this Example, a method for making 1-ethoxy-3,3,3-trifluoropropene is demonstrated. A 300-mL autoclave was charged with 40 mL of ethanol and 33.6 g of solid potassium hydroxide, and then the autoclave was sealed. 80 g of 1-chloro-3,3,3-trifluopropropene was condensed into the autoclave through a valve. The autoclave was heated to 70° C. and maintained at 70° C. for four hours. After 4 hours, the autoclave was cooled, and then opened. The contents of the autoclave were poured into water and then the mixture was shaken. After shaking, a lower organic layer formed and was separated from the mixture. The contents of the lower organic layer were dried over calcium chloride. The resulting dried organic mixture was distilled and 1-ethoxy-3,3,3-trifluoropropene was obtained.

### ASPECTS

Aspect 1 is an electrolyte solution for a lithium-ion cell, the electrolyte solution comprising at least one organic carbonate solvent; at least one lithium salt including a non-coordinating anion; and at least one polyfluorinated alkoxy olefin according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′, wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

Aspect 2 is the electrolyte solution of Aspect 1, wherein the at least one polyfluorinated alkoxy olefin is from 0.2 wt. % to 10 wt. % of a total weight the electrolyte solution.

Aspect 3 is the electrolyte solution of Aspect 1 or Aspect 2, wherein the at least one polyfluorinated alkoxy olefin consists essentially of a trans-isomer of the at least one polyfluorinated alkoxy olefin.

Aspect 4 is the electrolyte solution of Aspect 1 or Aspect 2, wherein the at least one polyfluorinated alkoxy olefin consists essentially of cis-isomer of the at least one polyfluorinated alkoxy olefin.

Aspect 5 is electrolyte solution of Aspect 1 or Aspect 2, wherein the at least one polyfluorinated alkoxy olefin includes an amount of a trans-isomer of the at least one polyfluorinated alkoxy olefin, as a percentage of the at least one polyfluorinated alkoxy olefin, from 1 wt. % to 99 wt. %.

Aspect 6 is the electrolyte solution of any one of Aspects 1-5, wherein the at least one polyfluorinated alkoxy olefin includes 1-methoxy-3,3,3-trifluoropropene.

Aspect 7 is the electrolyte solution of any one of Aspects 1-6, wherein the at least one polyfluorinated alkoxy olefin includes 1-ethoxy-3,3,3-trifluoropropene.

Aspect 8 is the electrolyte solution of any one of Aspects 1-7, wherein the at least one organic carbonate solvent includes at least one selected from the group of ethylene carbonate, propylene carbonate, ethyl methyl carbonate and diethyl carbonate.

Aspect 9 is the electrolyte solution of Aspect 8, wherein the at least one organic carbonate solvent includes ethylene carbonate, propylene carbonate and diethyl carbonate.

Aspect 10 is the electrolyte solution of Aspect 8, wherein the at least one organic carbonate solvent includes ethylene carbonate, diethyl carbonate, and ethyl methyl carbonate.

Aspect 11 is the electrolyte solution of any one of Aspects 1-10, wherein the lithium salt includes at least one selected from the group of lithium hexafluorophosphate, lithium tetrafluoroborate, lithium perchlorate and lithium bis(fluorosulfonyl)imide.

Aspect 12 is the electrolyte solution of any one of Aspects 1-11, wherein the lithium salt is from 0.5 wt. % to 15 wt. % of a total weight of the electrolyte solution.

Aspect 13 is the electrolyte solution of any one of Aspects 1-12, further including at least one additive selected from the group of vinylene carbonate, fluoroethylene carbonate, 2-propynyl methanesulfonate, cyclohexylbenzene, t-amyl benzene and adiponitrile.

Aspect 14 is a lithium-ion cell for a lithium-ion battery, the lithium-ion cell comprising a cathode; an anode; a porous separator disposed between the cathode and the anode; an electrolyte solution disposed between the cathode and the anode; and a solid electrolyte interphase layer disposed on the cathode and the anode, the solid electrolyte interface layer comprising a decomposition product of at least one polyfluorinated alkoxy olefin according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
   wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

Aspect 15 is the lithium-ion cell of Aspect 14, wherein the electrolyte solution comprises at least one organic carbonate solvent and at least one lithium salt including a non-coordinating anion.

Aspect 16 is the lithium-ion cell of Aspect 15, wherein the lithium salt is at least one selected from the group of lithium hexafluorophosphate, lithium tetrafluoroborate, lithium perchlorate and lithium bis(fluorosulfonyl)imide.

Aspect 17 is the lithium-ion cell of Aspect 16, wherein the lithium salt includes lithium hexafluorophosphate.

Aspect 18 is the lithium-ion cell of any one of Aspects 14-17, wherein the cathode includes lithium, nickel, cobalt, manganese and oxygen.

Aspect 19 is a method for making an electrolyte solution for a lithium-ion cell, the method comprising providing at least one polyfluorinated alkoxy olefin and combining the at least one polyfluorinated alkoxy olefin with at least one organic carbonate solvent and at least one lithium salt including a non-coordinating anion, wherein the at least one polyfluorinated alkoxy olefin is according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
   wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

Aspect 20 is the method of Aspect 19, wherein providing the at least one polyfluorinated alkoxy olefin comprises providing an alkane alcohol and an HFO monomer and reacting the alkane alcohol and the HFO monomer in the presence of a catalyst to form at least one polyfluorinated alkoxy olefin.

Aspect 21 is the method of Aspect 20, wherein the catalyst is an alkali hydroxide.

Aspect 22 is the method of any one of Aspects 19-21, wherein the at least one polyfluorinated alkoxy olefin is from 0.2 wt. % to 10 wt. % of a total weight the electrolyte solution.

Aspect 23 is the method of any one of Aspects 19-21, wherein the at least one polyfluorinated alkoxy olefin consists essentially of a trans-isomer of the at least one polyfluorinated alkoxy olefin.

Aspect 24 is the method of any one of Aspects 19-21, wherein the at least one polyfluorinated alkoxy olefin consists essentially of cis-isomer of the at least one polyfluorinated alkoxy olefin.

Aspect 25 is the method of any one of Aspects 19-21, wherein the at least one polyfluorinated alkoxy olefin includes an amount of a trans-isomer of the 1 at least one polyfluorinated alkoxy olefin, as a percentage of the at least one polyfluorinated alkoxy olefin, from 1 wt. % to 99 wt. %.

Aspect 26 is the method of any one of Aspects 19-25, wherein the at least one polyfluorinated alkoxy olefin includes 1-methoxy-3,3,3-trifluoropropene.

Aspect 27 is the method of any one of Aspects 19-25, wherein the at least one polyfluorinated alkoxy olefin includes 1-ethoxy-3,3,3-trifluoropropene.

Aspect 28 is the method of any one of Aspects 19-27, wherein the at least one organic carbonate solvent includes at least one selected from the group of ethylene carbonate, propylene carbonate, ethyl methyl carbonate and diethyl carbonate.

Aspect 29 is the method of Aspect 28, wherein the at least one organic carbonate solvent includes ethylene carbonate, propylene carbonate and diethyl carbonate.

Aspect 30 is the method of Aspect 28, wherein the at least one organic carbonate solvent includes ethylene carbonate, diethyl carbonate, and ethyl methyl carbonate.

Aspect 31 is the method of any one of Aspects 19-30, wherein the lithium salt includes at least one selected from the group of lithium hexafluorophosphate, lithium tetrafluoroborate, lithium perchlorate and lithium bis(fluorosulfonyl)imide.

Aspect 32 is the method of any one of Aspects 19-31, wherein the lithium salt is from 0.5 wt. % to 15 wt. % of a total weight of the electrolyte solution.

Aspect 33 is the method of any one of Aspects 19-32, further including at least one additive selected from the group of vinylene carbonate, fluoroethylene carbonate, 2-propynyl methanesulfonate, cyclohexylbenzene, t-amyl benzene and adiponitrile.

1. An electrolyte solution for a lithium-ion cell, the electrolyte solution comprising:
at least one organic carbonate solvent;
at least one lithium salt including a non-coordinating anion; and
at least one polyfluorinated alkoxy olefin according to the general formula I,
the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
wherein Rₐ and Rₐ′ are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

2. The electrolyte solution of claim 1, wherein the at least one polyfluorinated alkoxy olefin is from 0.2 wt. % to 10 wt. % of a total weight the electrolyte solution.

3. The electrolyte solution of claim 1, wherein the at least one polyfluorinated alkoxy olefin consists essentially of a trans-isomer of the at least one polyfluorinated alkoxy olefin.

4. The electrolyte solution of claim 1, wherein the at least one polyfluorinated alkoxy olefin consists essentially of cis-isomer of the at least one polyfluorinated alkoxy olefin.

5. The electrolyte solution of claim 1, wherein the at least one polyfluorinated alkoxy olefin includes an amount of a trans-isomer of the at least one polyfluorinated alkoxy olefin, as a percentage of the at least one polyfluorinated alkoxy olefin, from 1 wt. % to 99 wt. %.

6. The electrolyte solution of claim 1, wherein the at least one polyfluorinated alkoxy olefin includes 1-methoxy-3,3,3-trifluoropropene.

7. The electrolyte solution of claim 1, wherein the at least one polyfluorinated alkoxy olefin includes 1-ethoxy-3,3,3-trifluoropropene.

8. The electrolyte solution of claim 1, wherein the at least one organic carbonate solvent includes at least one selected from the group of ethylene carbonate, propylene carbonate, ethyl methyl carbonate and diethyl carbonate.

9. The electrolyte solution claim 1, wherein the lithium salt includes at least one selected from the group of lithium hexafluorophosphate, lithium tetrafluoroborate, lithium perchlorate and lithium bis(fluorosulfonyl)imide.

10. The electrolyte solution of claim 1, wherein the lithium salt is from 0.5 wt. % to 15 wt. % of a total weight of the electrolyte solution.

11. The electrolyte solution of claim 1, further including at least one additive selected from the group of vinylene carbonate, fluoroethylene carbonate, 2-propynyl methanesulfonate, cyclohexylbenzene, t-amyl benzene and adiponitrile.

12. A lithium-ion cell for a lithium-ion battery, the lithium-ion cell comprising:
a cathode;
an anode;
a porous separator disposed between the cathode and the anode;
an electrolyte solution disposed between the cathode and the anode; and
a solid electrolyte interphase layer disposed on the cathode and the anode, the solid electrolyte interface layer comprising a decomposition product of at least one polyfluorinated alkoxy olefin according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

13. The lithium-ion cell of claim 12, wherein the electrolyte solution comprises:
at least one organic carbonate solvent; and
at least one lithium salt including a non-coordinating anion.

14. The lithium-ion cell of claim 13, wherein the lithium salt is at least one selected from the group of lithium hexafluorophosphate, lithium tetrafluoroborate, lithium perchlorate and lithium bis(fluorosulfonyl)imide.

15. The lithium-ion cell of claim 14, wherein the lithium salt includes lithium hexafluorophosphate.

16. The lithium-ion cell of claim 12, wherein the cathode includes lithium, nickel, cobalt, manganese and oxygen.

17. A method for making an electrolyte solution for a lithium-ion cell, the method comprising:
providing at least one polyfluorinated alkoxy olefin; and
combining the at least one polyfluorinated alkoxy olefin with at least one organic carbonate solvent and at least one lithium salt including a non-coordinating anion, wherein the at least one polyfluorinated alkoxy olefin is according to the general formula I, the general formula II, or the general formula III:
I: RₐR_{b}C═CH—O—R,
II: RₐR_{b}C═CH—O—CHRₐ′R_{b}′,
III: RₐR_{b}C═CH—O—R_{c}—O—CH═CRₐ′R_{b}′,
wherein Rₐ and Rₐ40 are each independently a fluorinated alkyl group having 1 or 2 carbon atoms, R_{b} and R_{b}′ are each independently F, Cl, Br or H, and R is CₙHₓF_{y}, wherein n is an integer from 1 to 6, x and y are each independently integers from 0 to 13, and x+y=2n+1 or x+y=2n−1, and R_{c} is CₖH₍₂ₖ₊₁₎, wherein k is an integer from 2 to 4.

18. The method of claim 17, wherein providing the at least one polyfluorinated alkoxy olefin comprises:
providing an alkane alcohol and an HFO monomer; and
reacting the alkane alcohol and the HFO monomer in the presence of a catalyst to form at least one polyfluorinated alkoxy olefin.

19. The method of claim 18, wherein the catalyst is an alkali hydroxide.

20. The method of claim 17, wherein the at least one polyfluorinated alkoxy olefin includes an amount of a trans-isomer of the 1 at least one polyfluorinated alkoxy olefin, as a percentage of the at least one polyfluorinated alkoxy olefin, from 1 wt. % to 99 wt. %.
